(19) United States
(12) Patent Application Publication
(10) Pub. No.: US 2019/0095877 A1
(43) Pub. Date: Mar. 28, 2019

(54) IMAGE RECOGNITION SYSTEM FOR RENTAL VEHICLE DAMAGE DETECTION AND MANAGEMENT

(71) Applicant: PANTON, INC., Houston, TX (US)

(72) Inventor: Saishi Frank LI, Sugar Land, TX (US)

(21) Appl. No.: 16/142,620

(22) Filed: Sep. 26, 2018

Related U.S. Application Data
(60) Provisional application No. 62/563,487, filed on Sep. 26, 2017.

(51) Int. Cl. G06Q 10/00; G06K 9/00; G06K 9/32; G06K 9/62; G06Q 30/02; G06N 99/00

(52) U.S. Cl. CPC G06Q 10/20; G06K 9/00671; G06K 9/00771; G06K 9/3258; G06K 2209/01; G06K 9/6262; G06Q 30/0283; G06N 99/005; G06K 2209/23; G06K 9/6256

(57) ABSTRACT

Techniques are disclosed for rental vehicle damage detection and automatic rental vehicle management. In one embodiment, a rental vehicle management application receives video and/or images of a rental vehicle's exterior and dashboard and processes the video and/or images to determine damage to the vehicle as well as the vehicle's mileage and fuel level. A machine learning model may be trained using image sets, extracted from larger images of vehicles, that depict distinct types of damage to vehicles, as well as image sets depicting undamaged vehicles, and the management application may apply such a machine learning model to identify and classify vehicle damage. The management application further determines sizes of vehicle damage by converting the damage sizes in pixels to real-world units, and the management application then generates a report and receipt indicating the damage to the vehicle if any, mileage, fuel level, and associated costs.

### CROSS-REFERENCE TO RELATED APPLICATIONS

This application claims priority to U.S. provisional application having Ser. No. 62/563,487, filed on Sep. 26, 2017, which is hereby incorporated by reference in its entirety.

### BACKGROUND

### Field of the Invention

Embodiments of the disclosure presented herein relate generally to computer image processing and, in particular, to automated image recognition techniques for rental vehicle damage detection and management.

### Description of the Related Art

Rental car companies spend enormous amounts to manage their core assets, the vehicles themselves. Vehicles that are rented out are typically inspected upon their return. Traditionally, a rental car company employee personally greets a customer, visually inspects the condition of the customer's rental vehicle, checks the rental vehicle's mileage (both the miles driven and the odometer) and fuel gauge, and prints a paper invoice or receipt. The traditional inspection process tends to be slow and labor intensive. Such traditional inspections are also prone to human error, such as overlooking vehicle damage during the visual inspection or misreading the mileage or fuel gauge.

Handheld devices have evolved to provide sophisticated computing platforms, complete with touch-sensitive display surfaces and cameras, among other components. Further, the computing power of these devices has steadily increased, allowing sophisticated computing applications to be executed from the palm of one's hand.

### SUMMARY

One embodiment includes a method for detecting vehicle damage. The method generally includes training a machine learning model to identify and classify damage to vehicles. The machine learning model is trained using, at least in part, one or more sets of images that each depicts a respective type of vehicle damage and a set of images that do not depict vehicle damage. The method further includes receiving one or more images which provide a 360 degree view of an exterior of a vehicle. In addition, the method includes determining damage to the vehicle as depicted in the received images using the trained machine learning model.

Further embodiments provide a non-transitory computer-readable medium that includes instructions that, when executed, enable a computer to implement one or more aspects of the above method, and a computer system programmed to implement one or more aspects of the above method.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram illustrating an approach for detecting vehicle damage using a machine learning model, according to an embodiment.

FIG. 2 illustrates a rental vehicle customer using a handheld device to record a video of a rental vehicle while walking around the vehicle, according to an embodiment.

FIG. 3 illustrates an example of fixed cameras that may be used to capture images depicting a 360 degree view of a vehicle that is driving across a pavement, according to an embodiment.

FIG. 4 illustrates a system configured to detect vehicle damage and manage rental vehicles, according to an embodiment.

FIG. 5 illustrates an example of a handheld device, according to an embodiment.

FIG. 6 illustrates a method for rental vehicle damage detection and reporting, according to an embodiment.

### DETAILED DESCRIPTION OF EXEMPLARY EMBODIMENTS

Embodiments of the disclosure presented herein provide techniques for rental vehicle damage detection and management. In one embodiment, a rental vehicle management application, which may run in a server or in the cloud, receives video and/or images of a rental vehicle's exterior and dashboard. For example, the video and/or images may be captured by a customer using his or her handheld device (e.g., a mobile phone) as the customer walks around the rental vehicle, thereby providing a 360 degree view of the vehicle's exterior from the front, back, and sides of the vehicle. As another example, a 360 degree view of the vehicle's exterior may be provided by images captured using fixed cameras with different vantage points that are strategically placed along a pavement that the rental vehicle drives across. Video and/or images may also be captured from an elevated view if, e.g., the top of the vehicle is suspected of being damaged. The management application processes the video and/or images of the vehicle's exterior, as well as video and/or images captured of the vehicle's dashboard, to determine vehicle damage, mileage, fuel level, and/or associated costs. In one embodiment, a machine learning model may be trained using (1) sets of images that each depict a distinct type of vehicle damage (e.g., dents or scratches), and (2) an image set depicting undamaged vehicles or regions thereof. In such a case, the management application uses the trained machine learning model to identify and classify vehicle damage, and the management application further determines sizes of the determined vehicle damage and an associated cost of repairs by converting the sizes in pixels to real-world units (e.g., feet or meters), based on a known size of the vehicle's make, model, and year. In addition, the management application may generate and transmit to the customer's handheld device a report and receipt indicating the damage to the vehicle, the mileage, the fuel level, and/or associated costs.

Herein, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provisioning of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a rental vehicle management application) or related data available in the cloud. For example, a rental vehicle management application could execute on a computing system in the cloud and process videos and/or images to determine rental vehicle damage, mileage, fuel levels, etc., as disclosed herein. Doing so allows a user to access this information from any computing system attached to a network connected to the cloud (e.g., the Internet).

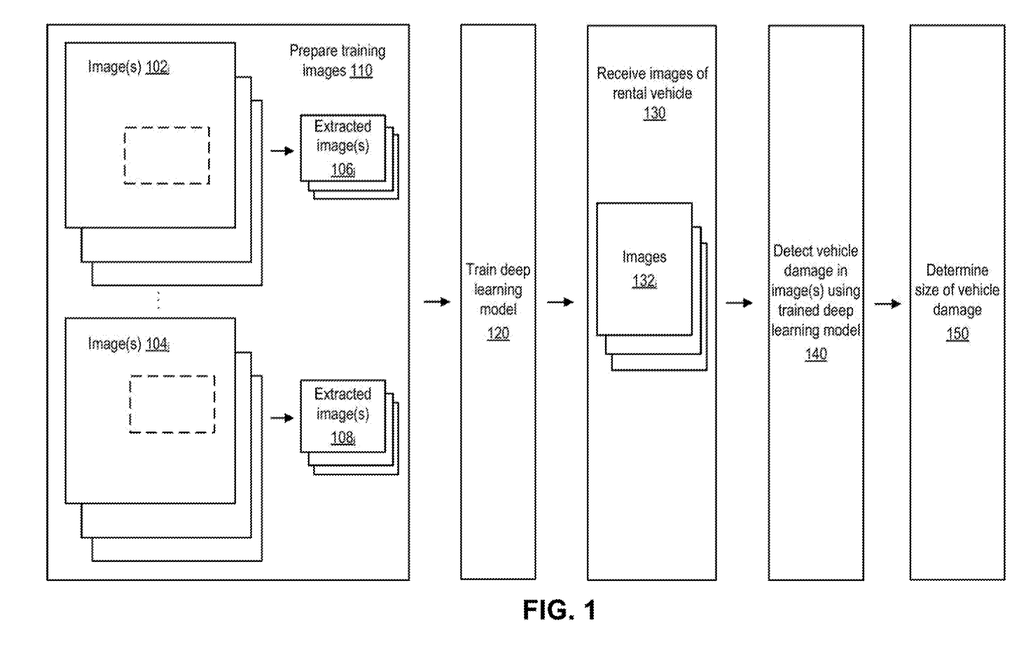

Referring now to FIG. 1, a diagram illustrating an approach for detecting vehicle damage using a machine learning model is shown. As shown, training images are prepared at 110 by extracting image regions 106ᵢ and 108ᵢ that depict vehicle damage from images 102ᵢ and 104ᵢ, respectively, that depict vehicles. One or more image regions may be extracted from each of the images 102ᵢ and 104ᵢ. For example, the image regions 106ᵢ and 108ᵢ that depict vehicle damage may be extracted manually from the images 102ᵢ and 104ᵢ, respectively. Although shown as distinct image sets 102 and 104, some or all of the images in the image sets 102 and 104 may be the same.

Each of the images 102ᵢ and 104ᵢ may depict one or more vehicles, such as an automobile of a particular make, model, and year. Further, each of the sets of images 106ᵢ and 108ᵢ depict a distinct type of vehicle damage as shown in portions of the images 102ᵢ and 104ᵢ. The image sets 106ᵢ and 108ᵢ depicting distinct types of damage may be used as positive training sets in training the machine learning model, while portions of the images 102ᵢ and 104ᵢ (or other images) depicting undamaged (portions of) vehicles may be used as negative training sets. For example, the extracted images 106ᵢ and 108ᵢ may include images depicting the following types of vehicle damage: dents in the bodies of the vehicles and scratches on the vehicles. Detection of other types of vehicle damage is also contemplated. As new images are received (e.g., showing an open cut of the vehicle body), the machine learning model may be trained to identify newly learned damage types.

At 120, the machine learning model is trained using the extracted images 106ᵢ and 108ᵢ that depict different types of vehicle damage and extracted images (or other images) depicting (portions of) undamaged vehicles. Any feasible machine learning model and training algorithm may be employed. For example, a deep learning model such as a convolution neural network, a region proposal network, a deformable parts model, or the like may be used as the machine learning model. Although described for simplicity herein with respect to one machine learning model, it should be understood that multiple such models may be trained and thereafter used (e.g., an ensemble of trained machine learning models). Further, the training may not require all of the layers of the machine learning model (e.g., the convolutional neural network) to be trained. For example, transfer learning may be employed to re-train some layers (e.g., the classification layers of a convolutional neural network) of a pre-trained machine learning model while leaving other layers (e.g., the feature extraction layers of the convolutional neural network) fixed. Once trained, the machine learning model may take as input images of vehicles and output identified locations of vehicle damage and/or classifications of the vehicle damage by type. The machine learning model may be trained using, e.g., a backpropagation algorithm or another suitable algorithm. It should be understood that the machine learning model can also be re-trained (e.g., periodically) at a later time using additional training sets derived from videos and/or images received from rental car customers, such that the identification and classification accuracy of the machine learning model may continuously improve.

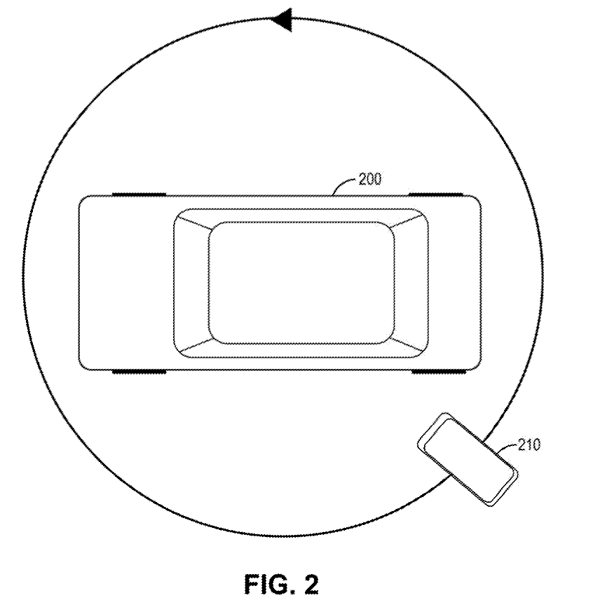

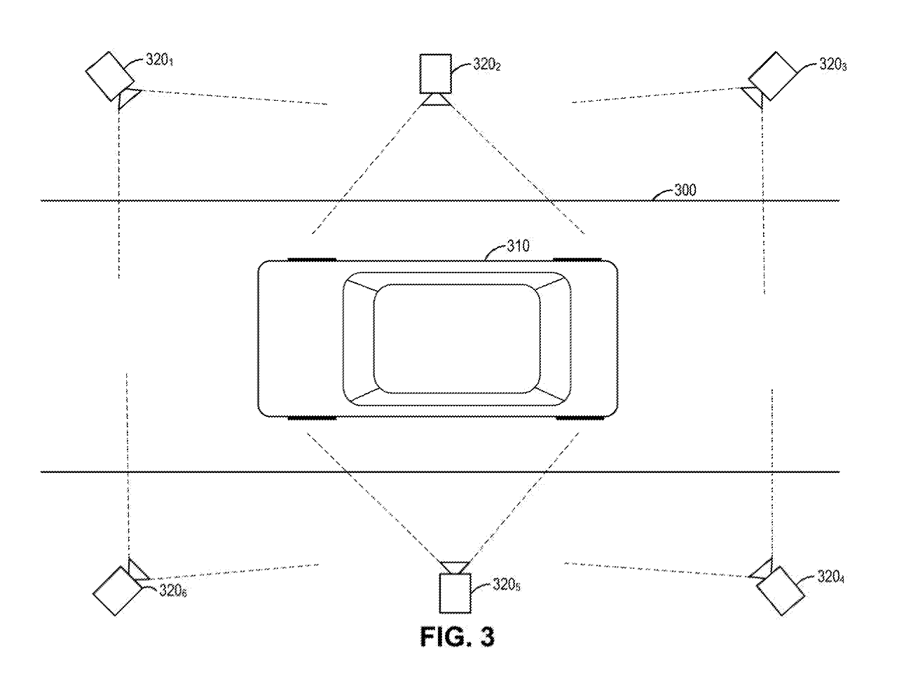

At 130, images 132ᵢ of a rental vehicle's exterior are received by a rental vehicle management application (also referred to herein as the “management application”). In one embodiment, such images may include frames from a video recording taken by a user walking around the rental vehicle. For example, as shown in FIG. 2, a customer may use a handheld device 210 to record a video of a rental vehicle 200 while walking around the vehicle 200 in a substantially circular path, with such a video providing a 360 degree view of the vehicle's exterior from the front, back, and sides of the vehicle 200. An application running in the customer's handheld device may then transmit the recorded video to the management application, which may run in a server or in the cloud. Although discussed herein primarily with respect to such a video, it should be understood that other images capturing a 360 degree view of a vehicle exterior or more may be employed in alternative embodiments. For example, in other embodiments, images may be taken at certain intervals as the user walks around the vehicle, a panoramic image may be taken as the user walks around the vehicle, etc. In yet another embodiment, the images may be recorded by fixed cameras, such as cameras having different vantage points that are strategically placed along a pavement across which the rental vehicle customers naturally drive. In such a case, the fixed cameras may also capture images and/or video providing a 360 degree view of the vehicle. FIG. 3 illustrates an example of fixed cameras 320₁₋₆ that may be used to capture images depicting a 360 degree view of a vehicle 310 that is driving across a pavement 300, according to an embodiment. Although a particular configuration of fixed cameras 320₁₋₆ is shown for illustrative purposes, other configurations and numbers of fixed (or even mobile) cameras that are capable of a 360 degree view of a vehicle driving across a pavement may be used in alternative embodiments.

At 140, the management application inputs some or all of the received images 132ᵢ into the trained machine learning model to detect vehicle damage in the input images. It should be understood that not all of the received images 132ᵢ need to be used, as the received images 132ᵢ may depict overlapping portions of the vehicle that are also depicted in other images. In one embodiment, a set of non-overlapping images may be selected from the received images as the input images. Given the input images, the trained machine learning model outputs locations (e.g., in the form of bounding boxes) of identified vehicle damage and classifications of the same (e.g., as dents or scratches) in one embodiment.

At 150, the management application determines sizes of the detected vehicle damage. Returning to the example above in which the machine learning model outputs bounding boxes identifying the locations of vehicle damage, the management application may determine the real-world sizes of those bounding boxes by converting the pixel height and width of the bounding boxes to real-world units (e.g., feet or meters) based on known dimensions of the rental vehicle's make, model, and year, or based on measurement directly from the images. For example, the management application may first segment the received images 132ᵢ, or a subset of such images, into foreground (depicting the vehicle) and background based on features such as the color, thickness, etc. computed for pixels in the images 132ᵢ or subset of images. Then, the management application may determine a conversion factor for converting a height in one of the images to a real-world height by computing a ratio between the height of the vehicle in pixels and a known height of the vehicle in feet (or meters). For example, such a conversion factor may be determined for each image, as the height of the vehicle may appear different in different images. A conversion factor for converting width in each image to real-world width may be determined in a similar manner based on the known width or circumference of the vehicle in feet (or meters) as compared to the width or circumference of the vehicle in the received images 132ᵢ, or a subset of those images Having obtained such conversion factors, the management application may use the conversion factors to convert sizes of the bounding boxes to real-world units.

In one embodiment, the management application may further estimate the cost to repair the identified damage based on the determined sizes of the bounding boxes, and/or based on damaged body parts according to an insurance repair code. For example, the management application may convert the determined sizes of the bounding boxes to real-world units (e.g., feet or meters) based on known dimensions of the rental vehicle's make, model, and year, or based on measurement directly from the images, and the management application may then multiply the real-word sizes by known unit costs of materials (e.g., metal, paint, plastic, etc.) to estimate the cost of repairs. The determined costs may then be included in, e.g., a report that the management application generates and transmits to the mobile application running in the customer's handheld device. That is, the customer may simply take a video with his or her handheld device while walking around the rental vehicle, and, in turn, the management application may identify and classify vehicle damage from the video and transmit a report and receipt back to the customer's handheld device indicating the damage and estimated cost of repairs, among other things.

In another embodiment, the management application may further process received image(s) of a rental vehicle dashboard to determine a mileage of the vehicle, as indicated by an odometer, and a fuel level of the vehicle, as indicated by a fuel gauge, and the management application may include the determined mileage and fuel level, as well as associated costs, in the report and receipt transmitted to the customer's handheld device. For example, a customer may take, with the same mobile application used to capture the video of the rental vehicle's exterior, an image of the vehicle's dashboard, and the mobile application may transmit the image of the vehicle dashboard to the management application. In turn, the management application may use optical character recognition (OCR) or any other feasible technique to identify the letters and numbers displayed on the dashboard, including the mileage indicated by the odometer. In addition, the management application may determine the fuel level based on, e.g., an angle of the arrow in the fuel gauge relative to the angle made by the empty and full fuel markers. For example, if the angle between the empty and full fuel markers is known to be 90 degrees and the angle made between the red arrow in the fuel gauge and the empty marker (i.e., the “E”) is determined to be 45 degrees, then the management application may determine the fuel level to be half full. The management application may also determine the fuel level based on character recognition of numerals or symbols indicating the fuel level.

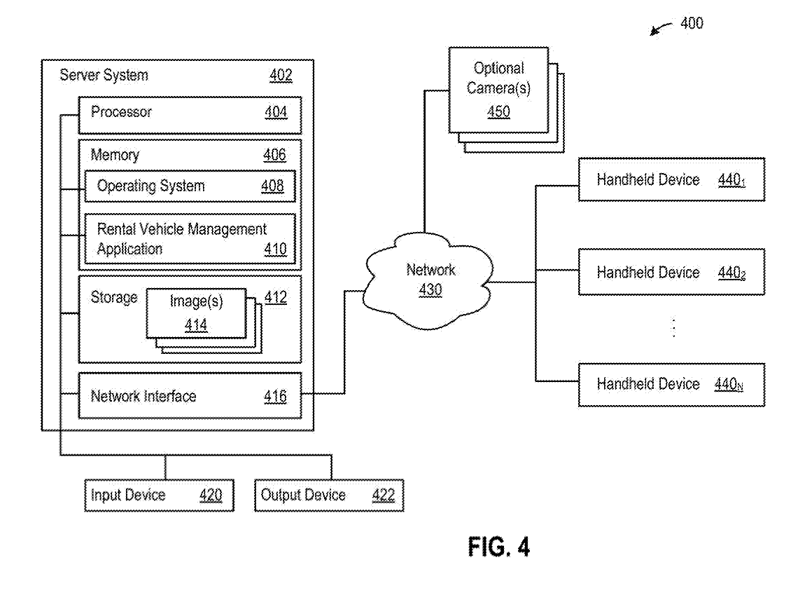

FIG. 4 illustrates a system 400 configured to detect rental vehicle damage and manage rental vehicles, according to an embodiment. As shown, the system 400 includes a server system 402 that is connected to handheld devices 460_{1-N} and cameras 450_{1-N} via a network 430. In general, the network 430 may be a telecommunications network and/or a wide area network (WAN). In one embodiment, the network 430 is the Internet.

The server 402 generally includes a processor 404 connected via a bus to a memory 406, a network interface device 410, a storage 412, an input device 420, and an output device 422. The server system 402 is under the control of an operating system 108. Examples of operating systems include the UNIX® operating system, versions of the Microsoft Windows® operating system, and distributions of the Linux® operating system. More generally, any operating system supporting the functions disclosed herein may be used. The processor 404 is included to be representative of a single central processing unit (CPU), multiple CPUs, a single CPU having multiple processing cores, one or more graphics processing units (GPUs), some combination of CPU(s) and GPU(s), and the like. The memory 406 may be a random access memory. The network interface device 116 may be any type of network communications device allowing the server system 402 to communicate with the handheld devices 460_{1-N} via the network 130.

The input device 420 may be any device for providing input to the server system 402. For example, a keyboard and/or a mouse may be used. The output device 422 may be any device for providing output to a user of the server system 402. For example, the output device 422 may be any conventional display screen or set of speakers. Although shown separately from the input device 420, the output device 422 and input device 420 may be combined. For example, a display screen with an integrated touch-screen may be used.

Illustratively, the memory 406 includes a rental vehicle management application 420. The rental vehicle management application 420 provides a software application configured to receive video and/or images from a mobile application running in handheld devices 440ᵢ and process the video and/or images. In one embodiment, the management application 420 is configured to receive videos and/or images captured using the mobile application and showing a 360 degree view of rental vehicles, as well as images captured using the mobile application showing the rental vehicles' dashboards. Illustratively, the storage 412 includes image(s) 414, which is representative of images and/or videos captured by the mobile application running in handheld devices 460_{1-N} and transmitted to the management application 420 that then persists such images and/or video as the image(s) 414 in a database in the storage 412.

In addition to persisting the image(s) 414 in the storage 412, the management application 420 is further configured to process some or all of the received images taken of a rental vehicle by inputting those images into a trained machine learning model. In one embodiment, the machine learning model may be trained using positive training sets comprising sets of images extracted from images depicting damaged vehicles, with each such extracted training set depicting a different type of damage, as well a negative training set comprising extracted images (or other images) depicting (portions of) undamaged vehicles. The machine learning model may also be re-trained using additional training sets derived from the videos and/or images received from rental vehicle customers. Once trained, such a machine learning model may be able to identify and classify damage to vehicles depicted in images input to the machine learning model, and the management application 420 may apply the trained machine learning model to detect vehicle damage in images and/or videos received from the handheld devices 440ᵢ. The management application 420 may further determine the sizes of detected vehicle damage by converting the sizes of the vehicle damage in pixels to real-world units (e.g., feet or meters) based on a known size of the vehicle. In addition, the management application 420 may process received images of rental vehicle dashboards to determine mileage as indicated by the odometers on the dashboards and fuel level as indicated by the fuel gauges on the dashboards. The management application 420 may then generate and transmit a report and a receipt back to a customer's handheld device 440 (and/or other parties, such as the rental car company or an insurance company) indicating, e.g., detected vehicle damage and estimated cost of repairs, as well as the miles driven, the fuel level, and any associated costs. In one embodiment, the management application 420 may also notify the rental vehicle company's personnel that the vehicle has been returned so that the vehicle can be cleaned and rented out to another customer.

In one embodiment, the management application 420 may use triangulation to generate a 3D model representing the rental vehicle and including any detecting vehicle damage. Triangulation works on the principle that a point's location in three-dimensional (3D) space can be recovered from images depicting that point from different angles. In one embodiment, the management application 420 may determine portions of frames of a video captured by the customer that overlap and recover the 3D locations of points in those overlapping portions. In particular, the management application 420 may compute features (e.g., color, shape, thickness, etc.) of each of the points in the video frames and determine matching points across video frames based on matching features of those points. In one embodiment, RANSAC (Random Sample Consensus) features may be computed. Having determined the location of a given point in at least three video frames, the management application 420 may then use triangulation to determine that point's location in 3D space. By repeating this process for multiple points, the management application 420 may generate a 3D point cloud. In one embodiment, the management application 420 may further add texture to the 3D point cloud by extracting the texture and color of each of the points and averaging over neighboring points.

In one embodiment, the management application 420 may also push to the customer's handheld device weather updates, including updates on any severe weather conditions near the rental vehicle determined based on a location of the handheld device 440 as identified by its global positioning system (GPS) sensor. Such weather updates may help the rental vehicle customer avoid weather conditions (e.g., hail, storms, etc.) that could damage the vehicle.

Although discussed herein primarily with respect to the management application's 420 interactions with applications running in the customers' handheld devices 440ᵢ, it should be understood that the management application 420 may also provide a platform that other parties can interact with. For example, the management application 420 may also permit insurance carriers to log in and view vehicle damage reports and cost estimates, which may be similar to the reports transmitted to the customers' handheld devices 440ᵢ. As another example, the management application 420 may also permit insurance adjusters or rental car company employees, as opposed to customers themselves, to capture videos and/or images of vehicles that are transmitted and processed by management application 420. In such a case, the management application 420 may further provide a user interface (e.g., a web-based interface) that the insurance adjusters or rental car company employees can use to enter notes and/or other information that the management application 420 may incorporate into vehicle damage and cost estimate reports. As yet another example, the management application 420 may also permit contractors such as vehicle service centers to view information on vehicle damage that the contractors are asked to repair.

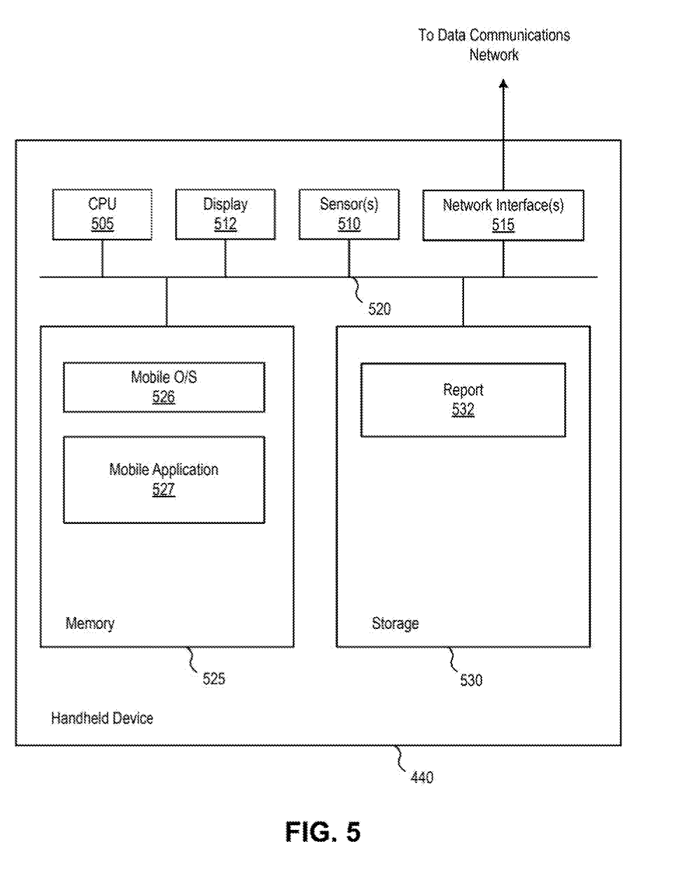

FIG. 5 illustrates an example of the handheld device 440, according to an embodiment. In this example, the handheld device 440 is presumed to be a handheld telephone with a touch sensitive display 512 and sensors(s) 510, including a camera. Of course, embodiments may be adapted for use with a variety of computing devices, including PDAs, tablet computers, digital cameras, drones, and other devices having a camera that can capture images and/or videos and network connectivity.

As shown, the handheld device 440 includes, without limitation, a central processing unit and graphics processing unit (CPU/GPU) 505, network interfaces 515, an interconnect 520, a memory 525, and storage 530. In addition, the handheld device includes a touch sensitive display 512 and sensor(s) 510. The sensor(s) 510 may be hardware sensors or software sensors, or sensors which include both hardware and software. In one embodiment, the sensor(s) 510 include one or more cameras that provide charge-coupled device (CCD) device(s) configured to capture still-images and videos. Other sensors that handheld device 440 may include may acquire data about, e.g., the device's position, orientation, and surrounding environment, among other things. For example, the device 440 may include a GPS component, proximity sensor(s), microphone(s), accelerometer(s), magnetometers(s), thermometer(s), pressure sensor(s), gyroscope(s), and the like.

The CPU/GPU 505 retrieves and executes programming instructions stored in the memory 525. Similarly, the CPU/GPU 505 stores and retrieves application data residing in the memory 525. The interconnect 520 is used to transmit programming instructions and application data between the CPU/GPU, storage 530, network interfaces 515, and memory 525. The CPU/GPU 505 is included to be representative of a single CPU, multiple CPUs, a single CPU having multiple processing cores, and the like. And the memory 525 is generally included to be representative of a random access memory. Storage 530, such as a hard disk drive or flash memory storage drive, may store non-volatile data.

Illustratively, the memory 525 includes a mobile operating system (O/S) 526 and an application 527. The mobile O/S 526 provides software configured to control the execution of application programs on the handheld device. The mobile O/S 526 may further expose application programming interfaces (APIs) which can be invoked to determine available device sensors, collect sensor data, and the like. The mobile application 527 is configured to run on the mobile O/S 526. For example, a rental vehicle customer may download the mobile application 527 when he or she books a rental vehicle (or at some other time), and a unique identifier (ID) may be assigned to the customer. The mobile application 527 may provide logistical aid to the customer during the vehicle rental and return process. For example, the mobile application 527 may receive, from the management application 420 when a customer books a rental vehicle, a photo of the vehicle, a parking lot location of the rental vehicle, and the like. The mobile application 527 displays such received information to the customer to help him or her locate the rented vehicle. Similarly, when the customer is returning the rental vehicle, the mobile application 527 may be used to display a map that guides the customer to a return location, as well as to display actions the customer should take during the return process. In one embodiment, the mobile application 527 may prompted the customer to take a video with the mobile application 527 while walking around the rental vehicle, thereby capturing a 360 degree view of the vehicle's exterior. In turn, the mobile application 527 may automatically transmit such a captured video to the management application 420, which as discussed is configured to detect vehicle damage by processing the frames of the video using a trained machine learning model, among other things. In alternative embodiments, the 360 degree view of the vehicle's exterior may be captured in other ways. For example, the customer may be prompted by the mobile application 527 to drive across a pavement along which fixed cameras are placed at different vantage points to capture a 360 degree view of the vehicle's exterior, and those cameras may be automatically triggered to capture images and/or videos that are then transmitted to the management application 420. As other examples, the customer may be prompted by the mobile application 527 to capture a panoramic image of the rental vehicle's exterior while walking around the rental vehicle, or the mobile application 527 may utilize a timer to automatically take pictures at predefined intervals as the customer walks around the rental vehicle, with the pictures being stitched together later by the management application 527.

In addition to capturing images and/or videos of the rental vehicle's exterior, the customer may be prompted to take image(s) of the rental vehicle's dashboard with the mobile application 527, and the mobile application 527 may also transmit such image(s) of the dashboard to the management application 420. In turn, the management application 420 may determine the vehicle's mileage and fuel level by, e.g., recognizing characters in the image(s) of the dashboard's odometer and an angle of an arrow in the dashboard's fuel gauge and/or character recognition of numerals or symbols indicating the fuel level, as described above.

In another embodiment, the mobile application 527 may receive and display weather updates from the management application 420 or elsewhere, including updates on any severe weather conditions near the rental vehicle, which may be determined based on the location of the handheld device 440 as identified by its GPS sensor. As described, such weather updates may help the rental vehicle customer avoid adverse weather conditions (e.g., hail, storms, etc.) that could damage the vehicle. In addition, the mobile application 527 may record the route that the customer drives using the handheld device's 440 GPS sensor (although the customer may be allowed to opt out of such recording) so that damage to the rental vehicle (e.g., hail damage) that is detected by the management application 420 can be correlated with severe weather conditions (e.g., a hail storm) along the customer's route. The miles drives may also be determined based on such a recorded route that the customer drives.

Of course, one of ordinary skill in the art will recognize that the handheld device 440 is provided as a reference example and that variations and modifications are possible as well as other devices, e.g., computing tablets with cameras or digital cameras that the customer may use to capture videos showing 360 degree views of rental vehicles and images of the rental vehicles' dashboards.

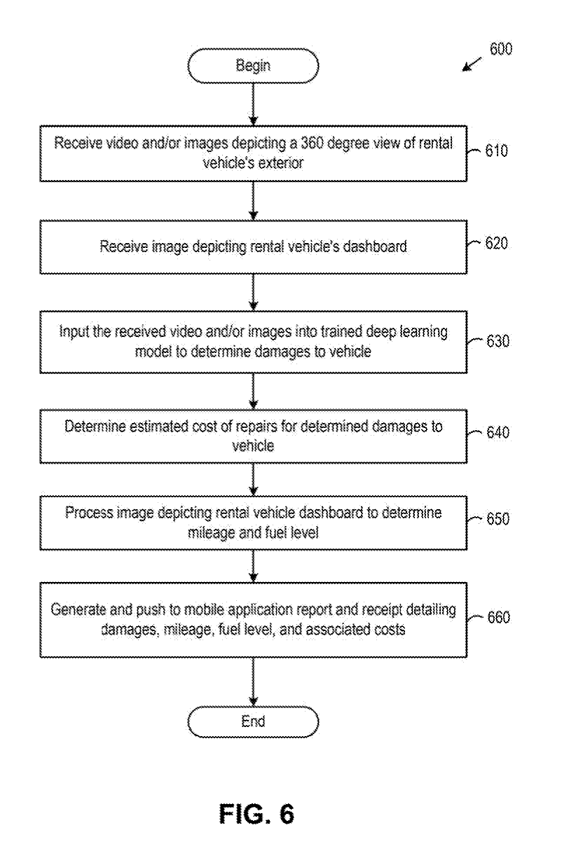

FIG. 6 illustrates a method 600 for rental vehicle damage detection and reporting, according to an embodiment. As shown, the method 600 begins at step 610, where the management application 420 receives a video and/or images depicting a 360 degree view of a rental vehicle's exterior. As described, the video and/or images may be captured in a number of different ways. In one embodiment, a rental vehicle customer may use his or her handheld device to capture a video as the customer walks around the vehicle, and a mobile application running in the handheld device may automatically transmit the captured video to the management application 420. In alternative embodiments, other types of videos and/or images may be captured, such as a panoramic image or images captured by fixed cameras that are placed at different vantage points along a pavement that the rental vehicle drives across.

At step 620, the management application 420 receives an image depicting the rental vehicle's dashboard. Similar to the video and/or images of the rental vehicle's exterior, the customer may capture the image depicting the rental vehicle's dashboard using a camera on his or her handheld device, and an application running in the handheld device may transmit the image of the dashboard to the management application 420.

At step 630, the management application 420 inputs the received video and/or images into a trained machine learning model to determine damage to the rental vehicle. As described, the machine learning model may be, e.g., a convolution neural network, a region proposal network, a deformable parts model, or any other feasible machine learning model. In one embodiment, such models may be trained to identify locations and classifications of vehicle damage using a backpropagation or other suitable algorithm and training images comprising image set(s), extracted from larger images of vehicles, that each depict a different type of damage, as well as extracted image regions (or other images) depicting undamaged vehicles as negative training set(s). The trained machine learning model may then take as input the received video and/or images and output the locations and classifications of vehicle damage. As described, the machine learning model can also be re-trained (e.g., periodically) using additional training sets derived from the videos and/or images that are received from rental car customers, such that the identification and classification accuracy of the machine learning model continuously improves as more videos and/or images are received.

In another embodiment, images depicting regions of interest that could include vehicle damage may be extracted from the received video and/or images, and the extracted images are then input into the trained machine learning model. For example, regions of interest may be extracted using a sliding window, a saliency map, and/or a region of interest detection technique, in the manner described in U.S. provisional patent application having Ser. No. 62/563,482, filed Sep. 26, 2017, the entire contents of which are incorporated by reference herein. Extraction of such images depicting regions of interest may narrow down the areas that need to be analyzed by the machine learning model and improve damage detection.

At step 640, the management application 420 determines an estimated cost of repairs for the vehicle damage determined at step 630. In one embodiment, the management application 640 may estimate the cost of repairs based on sizes of each of the image regions depicting vehicle damage. For example, the management application may convert the determined sizes of the bounding boxes in pixels to real-world units (e.g., feet or meters) based on known dimensions of the rental vehicle's make, model, and year, or based on measurement directly from the images, as described above. The management application may then multiply the real-word sizes by known unit costs of materials (e.g., metal, paint, plastic, etc.) to estimate the cost of repairs.

At step 650, the management application 420 processes the image depicting the rental vehicle dashboard to determine the vehicle's mileage and fuel level. In one embodiment, the management application 420 may identify letters and numbers displayed on the dashboard using, e.g., OCR, and the management application may determine the mileage based on the number shown at a known location of the odometer on the dashboard (for a given rental vehicle's make, model, and year). In addition, the management application may determine the rental vehicle's fuel level based on, e.g., an angle of the arrow in the fuel gauge relative to the angle made by the empty and full fuel markers and/or character recognition of numerals or symbols indicating the fuel level.

At step 660, the management application 420 generates and transmits to the customer's mobile application 527 (and/or other parties such as the rental car company or an insurance company) a report and receipt indicating the damage and estimated cost of repairs determined at steps 630-640, as well as any costs associated with the mileage and fuel level determined at step 650, among other things. As described, the management application 420 may also notify the rental vehicle company's personnel that the vehicle has been returned so that the vehicle can be cleaned and rented out to another customer.

Although described herein primarily with respect to photographic cameras, in other embodiments, other types of cameras may be used in lieu of or in addition to photographic cameras. For example, thermal camera(s) may be used in one embodiment to capture the heat signature of a rental vehicle. Certain heat signatures may indicate damage to a vehicle's interior and, similar to the training of a machine learning model to identify and classify a vehicle's exterior damage, the machine learning model may also be trained to identify and classify internal damage as indicated by thermal camera images.

Although described herein primarily with respect to rental vehicles, it should be understood that techniques disclosed herein may also be applicable to non-rental vehicles. For example, an insurance adjuster may capture video and/or images of a non-rental vehicle, which may then be automatically processed to identify vehicle damage and estimate costs according to the techniques disclosed herein.

Advantageously, techniques disclosed herein permit an accelerated rental vehicle return process in which a customer may capture video and/or images of a vehicle's exterior and dashboard that are automatically used to generate a report and receipt based on the vehicle's mileage, fuel level, and vehicle damage as depicted in the captured video and/or images. Vehicle damage may also be documented, as the captured videos and/or images may be persisted in a server or in the cloud. In addition, weather alerts may be transmitted to the rental vehicle customer's handheld device based on the location of the device to reduce the chances of vehicle damage due to severe weather.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method of detecting vehicle damage, comprising:
training a machine learning model to identify and classify vehicle damage, wherein the machine learning model is trained using, at least in part, one or more sets of images that each depicts a respective type of vehicle damage and a set of images that do not depict vehicle damage;
receiving one or more images which provide a 360 degree view of an exterior of a vehicle; and
determining damage to the vehicle as depicted in the received one or more images using, at least in part, the trained machine learning model.

2. The method of claim 1, wherein the one or more images include discrete images or frames of a video captured using a handheld device as a user walked around the vehicle.

3. The method of claim 1, wherein the one or more images include images captured by cameras placed at distinct vantage points along a pavement across which the vehicle drove.

4. The method of claim 1, wherein the sets of images that each depicts a respective type of vehicle damage include image regions extracted from images depicting vehicles.

5. The method of claim 1, further comprising:
receiving one or more images depicting a dashboard of the vehicle; and
determining, using the one or more images depicting the dashboard, at least one of a mileage of the vehicle based, at least in part, on character recognition of numerals indicating the mileage or a fuel level of the vehicle based, at least in part, on an angle formed by an arrow in a fuel gauge or a character recognition of numerals or symbols indicating the fuel level.

6. The method of claim 5, further comprising, generating and transmitting to a handheld device at least one of a report or a receipt indicating the determined damage to the vehicle, the mileage of the vehicle, the fuel level of the vehicle, and estimated costs.

7. The method of claim 6, wherein the estimated costs include costs to repair the determined damage based, at least in part, on a conversion of sizes of image regions depicting the determined damage from pixels to real-world units.

8. The method of claim 1, wherein the sets of images used to train the machine learning model and the received plurality of images includes images captured using a thermal camera.

9. The method of claim 1, further comprising, generating a three-dimensional (3D) virtual model of the vehicle based on triangulation of points in a plurality of the received images.

10. A non-transitory computer-readable storage medium storing instructions that, when executed by a processor, cause a computer system to perform operations for detecting vehicle damage, the operations comprising:
training a machine learning model to identify and classify vehicle damage, wherein the machine learning model is trained using, at least in part, one or more sets of images that each depicts a respective type of vehicle damage and a set of images that do not depict vehicle damage;
receiving one or more images which provide a 360 degree view of an exterior of a vehicle; and
determining damage to the vehicle as depicted in the received one or more images using, at least in part, the trained machine learning model.

11. The computer-readable storage medium of claim 10, wherein the one or more images include discrete images or frames of a video captured using a handheld device as a user walked around the vehicle.

12. The computer-readable storage medium of claim 10, wherein the one or more images include images captured by cameras placed at distinct vantage points along a pavement across which the vehicle drove.

13. The computer-readable storage medium of claim 10, wherein the sets of images that each depicts a respective type of vehicle damage include image regions extracted from images depicting vehicles.

14. The computer-readable storage medium of claim 10, the operations further comprising:
receiving one or more images depicting a dashboard of the vehicle; and
determining, using the one or more images depicting the dashboard, at least one of a mileage of the vehicle based, at least in part, on character recognition of numerals indicating the mileage or a fuel level of the vehicle based, at least in part, on an angle formed by an arrow in a fuel gauge or a character recognition of numerals or symbols indicating the fuel level.

15. The computer-readable storage medium of claim 14, the operations further comprising, generating and transmitting to a handheld device at least one of a report or a receipt indicating the determined damage to the vehicle, the mileage of the vehicle, the fuel level of the vehicle, and estimated costs.

16. The computer-readable storage medium of claim 15, wherein the estimated costs include costs to repair the determined damage based, at least in part, on a conversion of sizes of image regions depicting the determined damage from pixels to real-world units.

17. The computer-readable storage medium of claim 10, wherein the sets of images used to train the machine learning model and the received plurality of images includes images captured using a thermal camera.

18. The computer-readable storage medium of claim 10, the operations further comprising, generating a three-dimensional (3D) virtual model of the vehicle based on triangulation of points in a plurality of the received images.

19. A system, comprising:
a processor; and
a memory configured to perform an operation for detecting vehicle damage, the operation comprising:
training a machine learning model to identify and classify vehicle damage, wherein the machine learning model is trained using, at least in part, one or more sets of images that each depicts a respective type of vehicle damage and a set of images that do not depict vehicle damage,
receiving one or more images which provide a 360 degree view of an exterior of a vehicle, and
determining damage to the vehicle as depicted in the received one or more images using, at least in part, the trained machine learning model.

20. The system of claim 19, wherein the one or more images include at least one of discrete images or frames of a video captured using a handheld device as a user walked around the vehicle or images captured by cameras placed at distinct vantage points along a pavement across which the vehicle drove.
